(19) United States
(12) Patent Application Publication
(10) Pub. No.: US 2019/0366513 A1
(43) Pub. Date: Dec. 5, 2019

(54) Reconfigurable vises and related methods

(71) Applicant: Chicago Equipment Leasing Services Company, La Jolla, CA (US)

(72) Inventors: William Kousens, El Cajon, CA (US); Zachary Kousens, Carlsbad, CA (US); Tam Nguyen, San Diego, CA (US)

(21) Appl. No.: 15/995,032

(22) Filed: May 31, 2018

(51) Int. Cl. B25B 1/24

(52) U.S. Cl. CPC B25B 1/2478

(57) ABSTRACT

Disclosed are vises for machining work pieces. More specifically, disclosed may be a vise compatible with interchangeable or reconfigurable jaws positioned along a base with either (a) parallel and lengthwise series of securing ports or (b) parallel and lengthwise tracks.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of vises for machining work pieces. More specifically, the subject matter is a vise compatible with interchangeable or reconfigurable jaws.

### Background of the Invention

A vise is a mechanical apparatus used to secure an object, called a workpiece, in a desirable position for machining or other work to be performed on it. Workpieces are customarily secured against movement by a vise via sandwiching of the work piece between jaws of the vise. FIG. 0 illustrates a common vise 100 with: a jaw 110 and two face plates 111, 112; a crank 120 for moving the movable jaw 110 between open and closed positions along a lead or translation screw 121; and a base 130. In the most basic scenario, a workpiece (not shown) is simply clamped or pressed between the two-face plates 111, 112 by turning the crank 120 to drive the movable jaw 110a along the base 130 toward the stationary jaw 110b. In the embodiment shown in FIG. 1, the translation screw 121 is provided through a nut 122 that has been secured to the movable jaw 110a and rotatably positioned relative to the base 130 to drive linear motion of the nut 122 along the screw 121 and the movable jaw 110a relative to the base 130. In other embodiments, like the vise shown in FIG. 1 of U.S. Pat. No. 3,051,473 (Issued Aug. 28, 1962) by W. Juhase, a translational screw may be provided through a nut that has been secured to a base and rotatably secured to the movable jaw so that the screw linearly moves through the nut to drive the movable jaw along the base.

A double-station vise is essentially a double-jawed vise where the fixed jaw is shared by two moveable jaws with the same or separate translational screws. See e.g., FIG. 1 of U.S. Pat. No. 8,939,442 (issued Jan. 27, 2015); see also, e.g., FIG. 14 of U.S. Pat. No. 381,890 (issued Apr. 24, 1888). In some situations, a double-station vise could be considered a merger of two vises setup back-to-back. Double-station vises are often used to secure two work-pieces against the shared, fixed jaw so that two work pieces can be put in proximate positions for machining or other work to be performed on them.

These typical vises and double-station vises are essential and universal tools that assist in the manufacturing and customizing of various industrially machined products. Vises attract both commercial use amongst industrial manufacturers as well as personal use amongst hobbyists. One drawback of ordinary vises or double-station vises is that such vises are not reconfigurable. Without the ability for reconfiguration, these typical vises and double-station vises are not easily adaptable to workpieces of differing sizes or vising needs. The variety of possible uses and types of workpieces creates a demand for a vise or double-station vise with differing work-surface configurations. Thus, a need exits for double vise with interchangeable and removable jaw sets.

The below listed references are related to the subject matter disclosed in this application:
U.S. Pat. No. 381,890 by G. B. Taylor (issued Apr. 24, 1888) discloses a “machine vise;”
U.S. Pat. No. 417,307 by G. W. Baker (issued Dec. 17, 1889) discloses a “clamp;”
U.S. Pat. No. 1,954,708 by H. W. Mass (issued Apr. 10, 1934) discloses a “work holding clamp and drill jig;”
U.S. Pat. No. 2,093,297 by O. S. Weed (issued Sep. 14, 1937) discloses a “vise;”
U.S. Pat. No. 3,051,473 by W. Juhase (issued Aug. 28, 1962.) discloses a “hand vise for drill presses, milling machines and surface grinders;”
U.S. Pat. No. 3,063,707 by C. K. Kelley (issued Nov. 13, 1962) discloses a “machine shop vise;”
U.S. Pat. No. 3,630,512 by P. Paret (issued Dec. 28, 1971) discloses a “clamping device, particularly for a machine tool;”
U.S. Pat. No. 4,046,364 by R. L. Coope, et al (issued Sep. 6, 1977) discloses a “torque limiting vise for holding working on a machine tool table;”
U.S. Pat. No. 4,116,425 by O. J. Pesola (issued Sep. 26, 1978) discloses a “ski vise;”
U.S. Pat. No. 4,341,375 by M. Romanin (issued Jul. 27, 1982) discloses a “dual vise for skis and the like;”

U.S. Pat. No. 4,930,760 by Z. Mirkovic (issued Jun. 5, 1990) discloses a “multiple chucking fixture;”
U.S. Pat. No. 5,236,183 by K. K. Curtis (issued Aug. 17, 1993) discloses a “vise having modular jaws;”
U.S. Pat. No. 5,893,551 by J. R. Cousins (issued Apr. 13, 1999) discloses a “vise with fully machineable jaws;”
U.S. Pat. No. 6,017,026 by D. L. Durfee (issued Jan. 25, 2000) discloses a “machining vise;”
U.S. Pat. No. 8,109,494 by J. M. Warth (issued Feb. 7, 2012) discloses a “workholding apparatus having a movable jaw;”

U.S. Pat. No. 2,052,853 by C. P. Stuart (issued Sep. 1, 1936) discloses a “clamping device;”
U.S. Pat. No. 8,939,442 by W.-F. Wang (issued Jan. 27, 2015) discloses a double clamp vise;”
U.S. Pat. No. D436,012 by G. E. Lavigne et al. (issued Jan. 9, 2001) shows a “machining vise having a pivotal jaw assembly;”
U.S. Pat. No. D685,827 by E. S. Sun (issued Jul. 9, 2013) shows a “machine vise;”
U.S. Pat. No. 9,636,801 by S. Lee (issued May 2, 2017) discloses a “vise system having modular mechanism and method of manufacture;” and,
U.S. Pub. Pat. App. No. 2016/0214235 by C. Taylor (issued Jul. 28, 2016) discloses a “multi station fixture vise.”

### SUMMARY OF THE INVENTION

In view of the foregoing, an object of this specification is to disclose a rigid reconfigurable double-station vise. Another object of the specification is to disclose a mechanical apparatus that allows for the utilization of two jaw sets while also permitting a larger capacity of a single vise through removal of a center jaw. It is further an object of this description to disclose a rapidly reconfigurable device for accommodating workpieces of differing sizes and shapes. In a typical embodiment, the mechanical apparatus is defined by a main body formed from a single block exhibiting movable vise jaws and adjustable end plates for the securement of work pieces. The mechanical apparatus also includes a guide rod to enable incremental adjustments of the movable jaws. In one embodiment, the apparatus features two adjustable and interchangeable jaws that allow a user to utilize either end of the vise with differing jaw sets. Additionally, the center jaw piece can be removed to maximize capacity of the vise and allow for securement of larger work pieces as a single vise.

In one embodiment, the disclosed technology may be a double station vise apparatus comprising:
a base with a first end and a second end and at least one track that extends from the first end plate the length of the base to the other end plate;
a first end plate reconfigurably secured to the first end of the base within the track of the base via a foot of said first end plate;
a second end plate reconfigurably secured to the second end of the base within the track of the base via a foot of said first end plate;
a first jaw set that is slidably secured along the track;
a second jaw set that is slidably secured along the track;
a first lead screw that extends from the first end plate to the first jaw set, wherein the first lead screw slides the first jaw set along the track;
a second lead screw that extends from the second end plate to the second jaw set, wherein the second lead screw slides the second jaw set along the track and,
a removable center jaw piece that is slidably secured along the track and centrally and reconfigurably located on the base via a foot of the removable jaw piece.

In another embodiment, the disclosed technology may be a double station vise apparatus comprising:
a base with a first end and a second end, said base featuring at least one series of jaw securing openings;
a first end plate reconfigurably secured to the first end of the base via a stud provided through the end plate into one of said jaw securing openings of said series of jaw securing openings;
a second end plate reconfigurably secured to the second end of the base via another stud provided through the second end plate into another one of said jaw securing openings of said series of jaw securing openings;
at least one guide rod that extends from the first end plate the length of the base to the other end plate;
a first jaw set that is slidably secured along the guide rod;
a second jaw set that is slidably secured along the guide rod;
a first lead screw that extends from the first end plate to the first jaw set, whereby the first lead screw slides the first jaw set along the guide rod;
a second lead screw that extends from the second end plate to the second jaw set, whereby the second lead screw slides the second jaw set along the guide rod; and,
a removable center jaw piece that is slidably secured along the guide rod and centrally and reconfigurably located on the base via yet another stud provided through the removable center jaw piece into yet another one of said jaw securing openings of said series of jaw securing openings.

In one mode of use, the disclosed technology may involve a method of securing a machining work piece to a vise comprising the steps of:
obtaining a double vise apparatus comprising a base with a first end and a second end, a first end plate secured to the first end of the base, a second end plate secured to the second end of the base, at least one guide rod or track that extends from the first end plate along the length of the base to the other end plate, a first jaw set that is slidably secured along the guide rod or track, a second jaw set that is slidably secured along the guide rod or track, a first lead screw that extends from the first end plate to the first jaw set, whereby the first lead screw slides the first jaw set along the guide rod or track, a second lead screw that extends from the second end plate to the second jaw set, whereby the second lead screw slides the second jaw set along the guide rod or track, and a removable center jaw piece that is slidably secured along the guide rod or track and centrally located on the base;
obtaining a machining work piece;
adjusting the first lead screw until the first end plate is at a desired location along the double vise apparatus;
obtaining at least one face plate;
securing a face plate to the first jaw set;
securing a face plate to the wall opposing the first jaw set on the center jaw piece;
placing the machining work piece between the two face plates; and,
adjusting the first lead screw until the machining piece is secured between the two face plates.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 0 is a is a perspective view of a common prior-art vise 100;

FIG. 1 is a perspective view of a reconfigurable double-station vise;

FIG. 2 is an orthogonal front or back side view of the reconfigurable double-station vise from FIG. 1;

FIG. 3 is an orthogonal left or right side view of the reconfigurable double-station vise from FIG. 1;

FIG. 4 is an orthogonal top plan view of the reconfigurable double-station vise from FIG. 1;

FIG. 5 is an orthogonal bottom plan view of the reconfigurable double-station vise from FIG. 1;

FIG. 6A is a perspective view of a reconfigurable double-station vise base;

FIG. 6B is a front or back view of the reconfigurable the double-station vise base of FIG. 6A;

FIG. 6C is a left or right side view of the reconfigurable the double-station vise base of FIG. 6A;

FIG. 6D is a top plan view of the reconfigurable the double-station vise base of FIG. 6A;

FIG. 7A is a perspective view of a reconfigurable double-station vise end plate;

FIG. 7B is an orthogonal back side view of the reconfigurable double-station vise end plate of FIG. 7A;

FIG. 7C is an orthogonal left side view of the reconfigurable double-station vise end plate of FIG. 7A;

FIG. 7D is an orthogonal top view of the reconfigurable double-station vise end plate of FIG. 7A;

FIG. 8A is a perspective view of a reconfigurable double-station vise center jaw piece;

FIG. 8B is an orthogonal front or back side view of the reconfigurable double-station vise center jaw piece of FIG. 8A;

FIG. 8C is an orthogonal left or right side view of the reconfigurable double-station vise center jaw piece of FIG. 8A;

FIG. 8D is an orthogonal top view of the reconfigurable double-station vise center jaw piece of FIG. 8A;

FIG. 9A is a perspective view of a reconfigurable double-station vise movable jaw;

FIG. 9B is an orthogonal view of the reconfigurable double-station vise movable jaw of FIG. 9A;

FIG. 9C is an orthogonal back side view of the reconfigurable double-station vise movable jaw of FIG. 9A;

FIG. 9D is an orthogonal top plan view of the reconfigurable double-station vise movable jaw of FIG. 9A;

FIG. 10A is an environmental view of a reconfigurable double-station vise with movable jaws being incrementally adjusted along the base via a lead screw coaxially connecting the end plate to the movable jaw;

FIG. 10B is an environmental view of a reconfigurable double-station vise end plate showing a lead screw being turned or cranked to adjust the movable jaw location along the base;

FIG. 10C is an environmental side view of the reconfigurable double-station of FIG. 10A;

FIG. 10D is an environmental top plan view of the reconfigurable double-station of FIG. 10A;

FIG. 11A is a perspective view of a reconfigurable double-station vise showing the removal of removable, stabilizing plugs from the center jaw piece and end plates;

FIG. 11B is an environmental view of a reconfigurable double-station vise showing alternative placement of the center jaw piece and end plates before addition of the movable jaws;

FIG. 11C is an environmental view of the reconfigurable double-station vise with alternative placement of the center jaw piece and end plates with movable jaws placed on the reconfigurable double-station vise base;

FIG. 11D is an environmental view of a reconfigurable double-station vise with alternative placement of the center jaw piece and end plates with movable jaws placed on the reconfigurable double-station vise base secured to the base with removable, stabilizing plugs inserted into the center jaw piece, end plates, and movable jaws;

FIG. 11E is an environmental view of a reconfigurable double-station vise with alternative placement of the center jaw piece and end plates with movable jaws placed on the reconfigurable double-station vise base secured to the base with removable, stabilizing plugs inserted into the center jaw piece, end plates, and movable jaws and a lead screw coaxially connecting the end plats to the movable jaws;

FIG. 12 is a perspective view of a reconfigurable double-station vise;

FIG. 13 is an orthogonal front or back side view of the reconfigurable double-station vise from FIG. 12;

FIG. 14 is an orthogonal left or right side view of the reconfigurable double-station vise from FIG. 12;

FIG. 15 is an orthogonal top plan view of the reconfigurable double-station vise from FIG. 12;

FIG. 16 is an orthogonal bottom plan view of the reconfigurable double-station vise from FIG. 12;

FIG. 17A is a perspective view of a reconfigurable double-station vise base;

FIG. 17B is a front or back view of the reconfigurable the double-station vise base of FIG. 17A;

FIG. 17C is a left or right side view of the reconfigurable the double-station vise base of FIG. 17A;

FIG. 17D is a top plan view of the reconfigurable the double-station vise base of FIG. 17A;

FIG. 18A is a perspective view of a reconfigurable double-station vise end plate;

FIG. 18B is an orthogonal back side view of the reconfigurable double-station vise end plate of FIG. 18A;

FIG. 18C is an orthogonal left side view of the reconfigurable double-station vise end plate of FIG. 18A;

FIG. 18D is an orthogonal top view of the reconfigurable double-station vise end plate of FIG. 18A;

FIG. 18E is an orthogonal front side view of the reconfigurable double-station vise end plate of FIG. 18A;

FIG. 19A is a perspective view of a reconfigurable double-station vise center jaw piece;

FIG. 19B is an orthogonal front or back side view of the reconfigurable double-station vise center jaw piece of FIG. 19A;

FIG. 19C is an orthogonal left or right side view of the reconfigurable double-station vise center jaw piece of FIG. 19A;

FIG. 19D is an orthogonal top view of the reconfigurable double-station vise center jaw piece of FIG. 19A;

FIG. 19E is an orthogonal bottom view of the reconfigurable double-station vise center jaw piece of FIG. 19A;

FIG. 20A is a perspective view of a reconfigurable double-station vise movable jaw;

FIG. 20B is an orthogonal front view of the reconfigurable double-station vise movable jaw of FIG. 20A;

FIG. 20C is an orthogonal back side view of the reconfigurable double-station vise movable jaw of FIG. 20A;

FIG. 20D is an orthogonal top plan view of the reconfigurable double-station vise movable jaw of FIG. 20A;

FIG. 20E is an orthogonal side view of the reconfigurable double-station vise movable jaw of FIG. 20A;

FIG. 20F is an orthogonal bottom plan view of the reconfigurable double-station vise movable jaw of FIG. 20A;

FIG. 21A is a perspective view of a foot for a reconfigurable double-station vise end plate;

FIG. 21B is a side view of a foot for the reconfigurable double-station vise end plate of FIG. 21A;

FIG. 21C is a plan view of a foot for the reconfigurable double-station vise end plate of FIG. 21A;

FIG. 21D is another side view of a foot for the reconfigurable double-station vise end plate of FIG. 21A;

FIG. 22A is a perspective view of a foot for a reconfigurable double-station vise moveable jaw;

FIG. 22B is a side view of a foot for the reconfigurable double-station vise movable jaw of FIG. 22A;

FIG. 22C is a plan view of a foot for the reconfigurable double-station vise movable jaw of FIG. 21A;

FIG. 22D is another side view of a foot for the reconfigurable double-station vise movable jaw of FIG. 21A;

FIG. 22E is a view of a foot for the reconfigurable double-station vise movable jaw of FIG. 21A;

FIG. 23A is a perspective view of a lead nut for the movable plate;

FIG. 23B is front view of the lead nut of FIG. 23A;

FIG. 23C is a cross-section view of the lead nut of FIG. 23A;

FIG. 24A is a perspective view of a lead screw for the movable plate;

FIG. 24B is a side view of the lead screw of FIG. 24A;

FIG. 24C is a front view of the lead screw of FIG. 24A;

FIG. 24D is a back view of the lead screw of FIG. 25;

FIG. 25A is a perspective view of a lead washer for the movable plate;

FIG. 25B is side view of the lead washer of FIG. 25A;

FIG. 25C is a plan view of the lead nut of FIG. 25A;

FIG. 26A is a perspective view of a foot for a reconfigurable double-station vise center jaw piece;

FIG. 26B is a top view of a foot for the reconfigurable double-station vise center jaw piece of FIG. 26A;

FIG. 26C is a side view of a foot for the reconfigurable double-station vise center jaw piece of FIG. 26A;

FIG. 26D is another side view of a foot for the reconfigurable double-station vise center jaw piece of FIG. 26A;

FIG. 27A is an environmental view of a reconfigurable double-station vise with movable jaws being incrementally adjusted along the base via an lead screw coaxially connecting the end plate to the movable jaw;

FIG. 27B is an environmental view of a reconfigurable double-station vise end plate showing a lead screw being turned or cranked to adjust the movable jaw location along the base;

FIG. 27C is an environmental side view of the reconfigurable double-station vise of FIG. 27A;

FIG. 27D is an environmental top plan view of the reconfigurable double-station vise of FIG. 27A;

FIG. 28A is a schematic for assembling the disclosed reconfigurable double-station vise end plate and foot;

FIG. 28B is a schematic for assembling the disclosed reconfigurable double-station center jaw and foot;

FIG. 28C is a schematic for assembling the disclosed reconfigurable double-station vise movable jaw and foot;

FIG. 29A is a perspective view of a reconfigurable double-station vise showing a symmetrical placement of the central jaw piece, moveable jaws, and end plates;

FIG. 29B is an environmental view of the reconfigurable double-station vise with alternative placement of the center jaw piece and end plates with movable jaws placed on the reconfigurable double-station vise base;

FIG. 29C is an environmental view of a reconfigurable double-station vise with alternative placement of the center jaw piece and end plates with movable jaws placed on the reconfigurable double-station vise base;

FIG. 30 is a perspective view of a reconfigurable double-station vise;

FIG. 31 is an orthogonal top plan view of the reconfigurable double-station vise from FIG. 30;

FIG. 32 is an orthogonal left or right side view of the reconfigurable double-station vise from FIG. 30;

FIG. 33A is a perspective view of a reconfigurable double-station vise center jaw piece;

FIG. 33B is an orthogonal front or back side view of the reconfigurable double-station vise center jaw piece of FIG. 33A;

FIG. 33C is an orthogonal left or right side view of the reconfigurable double-station vise center jaw piece of FIG. 33A;

FIG. 33D is an orthogonal top view of the reconfigurable double-station vise center jaw piece of FIG. 33A; and,

FIG. 33E is an orthogonal bottom view of the reconfigurable double-station vise center jaw piece of FIG. 33A.

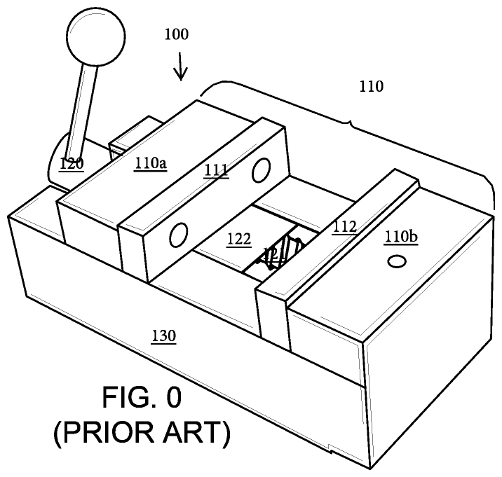

In the figures, the following reference numerals represent the associated components of the disclosed apparatus:
Reconfigurable double-station vise—1000;
End plate—1100;
External wall—1110;
Internal wall—1120;
Guide rod opening—1130;
Stud openings—1140;
Main body base—1200;
Jaw securing openings—1210;
Post holes—1220;
Movable jaw—1300;
Shaft openings—1310;
Lead screw opening—1320;
Center jaw piece—1400;
Center piece securing openings—1410;
Securing stud access opening—1420;
Jaw piece securing studs—2000
Guide rod—3000;
Jaw plate securing studs—4000;
Jaw plate securing stud openings—4110;
Lead screw—5000;
Reconfigurable double-station vise—1000;
End plate—1100;
External wall—1110;
Internal wall—1120;
Guide rod opening—1130;
Stud openings—1140;
Main body base—1200;
Jaw securing openings—1210;
Post holes—1220;
Movable jaw—1300;
Shaft openings—1310;
Lead screw opening—1320;
Center jaw piece—1400;
Center piece securing openings—1410;
Securing stud access opening—1420;
Jaw piece securing studs—2000
Guide rod—3000;
Jaw plate securing studs—4000;
Jaw plate securing stud openings—4110;
Lead screw—5000;
Reconfigurable double-station vise—1000;
End plate—1100;
External wall—1110;
Internal wall—1120;
Guide rod opening—1130;
Stud openings—1140;
Main body base—1200;
Jaw securing openings—1210;
Post holes—1220;
Movable jaw—1300;
Shaft openings—1310;
Lead screw opening—1320;
Center jaw piece—1400;
Center piece securing openings—1410;
Securing stud access opening—1420;
Jaw piece securing studs—2000
Guide rod—3000;
Jaw plate securing studs—4000;
Jaw plate securing stud openings—4110;
Lead screw—5000;
Reconfigurable double-station vise—6000;
End plate—6100;
External wall—6110;
Internal wall—6120;
End plate securing stud opening—6130;
Stud openings—6140;
Main body base—6200;
Jaw rail openings—6210;
Post holes—6220;
Movable jaw—6300;
Moveable jaw lateral stud openings—6310;
Lead screw opening—6320;
Moveable jaw foot peg openings—6330;
Center jaw piece—6400;
Center piece securing openings—6410;
Securing stud access opening—6420;
Center piece lateral stud opening—6430;
Center jaw foot peg opening—6440;
Jaw piece securing studs—7000
Jaw feet—8000
Movable jaw foot 8100;
Center jaw foot—8200;
End plate foot—8300;
Jaw foot peg opening—8400;
Jaw plate securing studs—9000;
Jaw plate securing stud openings—9110;
Lead screw—10000;
Fixed jaw—11000;
Fixed jaw stud opening—11100;
Fixed jaw foot peg opening—11200; and
Fixed jaw lateral stud opening—11300.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Disclosed generally is a reconfigurable double-station vise apparatus. In use, the device may be used to secure workable pieces in place for machining or manufacturing. The more specific aspects of the disclosed device are described below with reference to the appended figures.

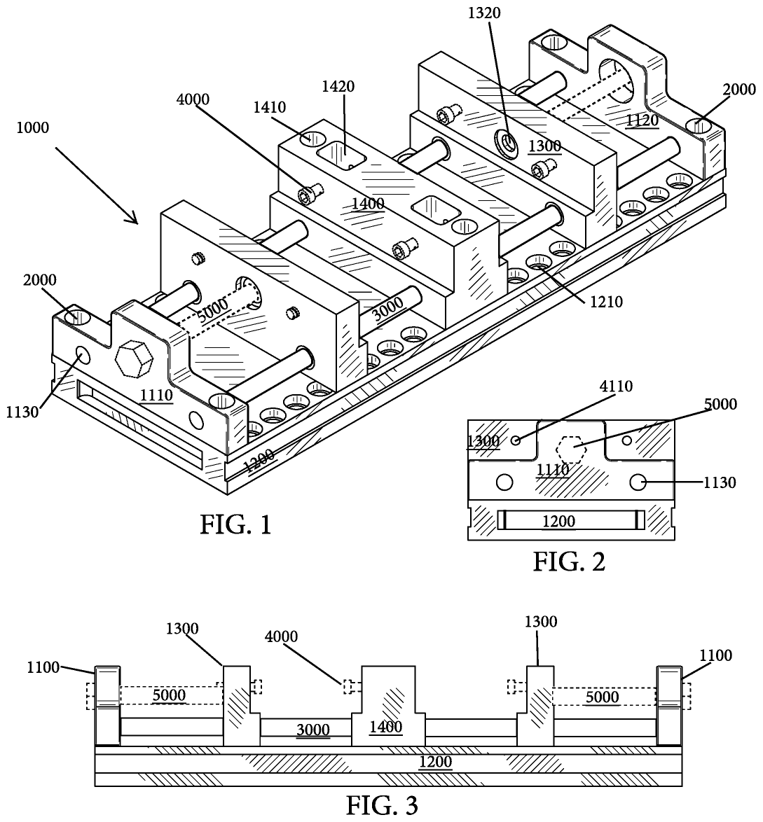

FIG. 1 is a perspective view of the reconfigurable double-station vise apparatus 1000 showing the center jaw piece 1400, two movable jaws 1300, two end plates 1110, 1120, fixated to the main body base 1200 via removable, jaw securing studs 2000. As shown, two (2) guide rods 3000 are inserted or otherwise threaded through shaft openings 1310 of the end plates 1110, movable jaws 1300, and center jaw piece 1400. Preferably, the endplates 1110, 1120 and center jaw 1400 are fixed to the guide rods 3000 while the movable jaws 1300 are slidably associated with the guide rods 3000 so that the movable jaws 1300 can advance or retreat relative to the movable base 1200. Suitably, the lead screw 5000 connects the end plates 1100 to the movable jaws 1300. Incremental lateral movement of the movable jaws 1300 is achieved via twisting the lead screw 5000 from its distal end protruding from the center of the end plate 1100. The end plates 1100 are secured to the main body base 1200 via jaw securing studs 2000 provided into stud openings 1140 and subsequently varying post holes 1210.

FIG. 2 is an orthogonal view of a reconfigurable double-station vise apparatus 1000. The figure shows guide rod openings 1130 perforating the external wall 1110 of the end plate 1100, the lead screw 5000 and the jaw plate securing stud openings 4110 on the movable jaw 1300 situated between the end plate 1100 and center jaw piece 1400 over the base 1200.

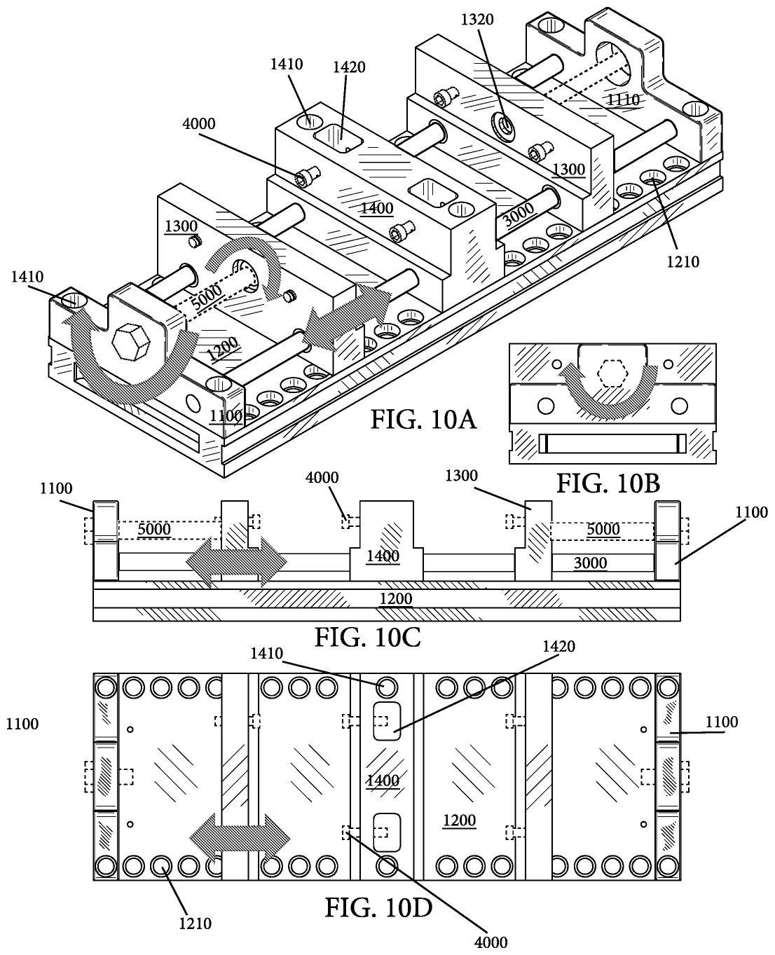

FIG. 3 is another orthogonal view of a reconfigurable double-station vise apparatus 1000 of FIG. 1. FIG. 3 shows the center jaw piece 1400, the movable jaw 1300, and the end plates 1100 fixated to the main body base 1200. FIG. 3 also shows the lead screws 5000 connecting the end plates 1100 to the movable jaws 1300 with jaw plate securing studs 4000 provided to the movable jaws 1300 and center jaw piece 1400. In one embodiment, as discussed below in connection with FIGS. 10A-10D, the end plates 1100, movable jaw 1300, and the center jaw piece 1400 are all fixated to the main body base 1200 to allow for two separate work pieces to be secured between the center jaw piece 1400 and either movable jaw 1300 on opposing sides of the center jaw piece 1400.

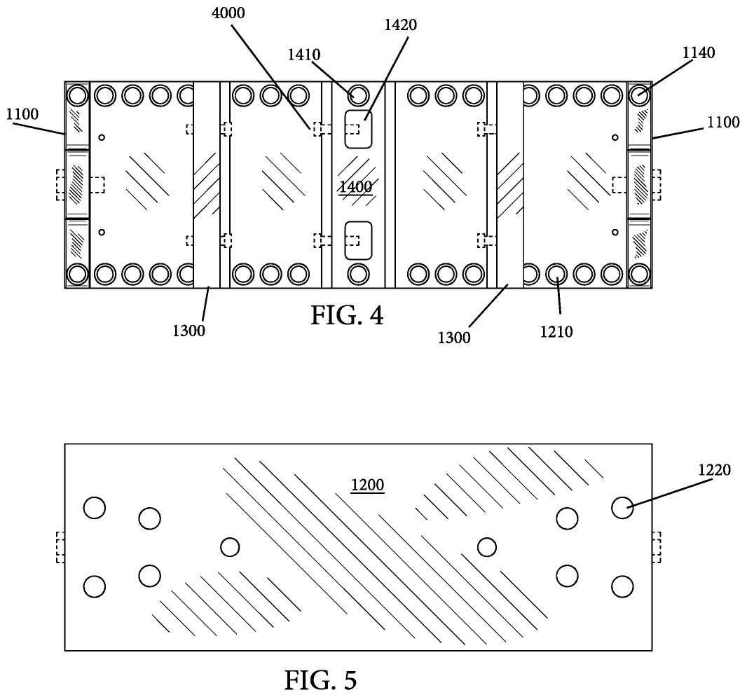

FIG. 4 is an orthogonal top plan view of a reconfigurable double-station vise apparatus 1000 of FIG. 1. As shown, the end plates 1100, the movable jaw 1300, and center jaw piece 1400 may be fixated to the main body base 1200. The end plates 1100 are fixed to the base 1200 via a jaw securing stud 2000 provided through the end plate 1100 and into the post holes 1210 of the base. The center jaw 1400 is secured to the base 1200 via center piece securing openings 1410. Jaw plate securing studs 4000 are fixated to the movable jaw 1300 and center jaw piece 1400. The jaw plate securing studs 4000 perforate at least one vertical surface of the center jaw piece 1400 and penetrate the inner vertical surface securing stud access opening 1420. FIG. 4 also gives an orthogonal view of the reconfigurable double-station vise apparatus 1000 from the top showing jaw securing openings 1210 along the main body base 1200.

FIG. 5 is an orthogonal bottom plan view of a reconfigurable double-station vise apparatus 1000. As shown, the main body base 1200 features post holes 1220 for securement to a machine tool table. Also shown, the post holes 1210 from the top surface (see FIG. 4) of the base (1200) preferably do not extend all the way through the base.

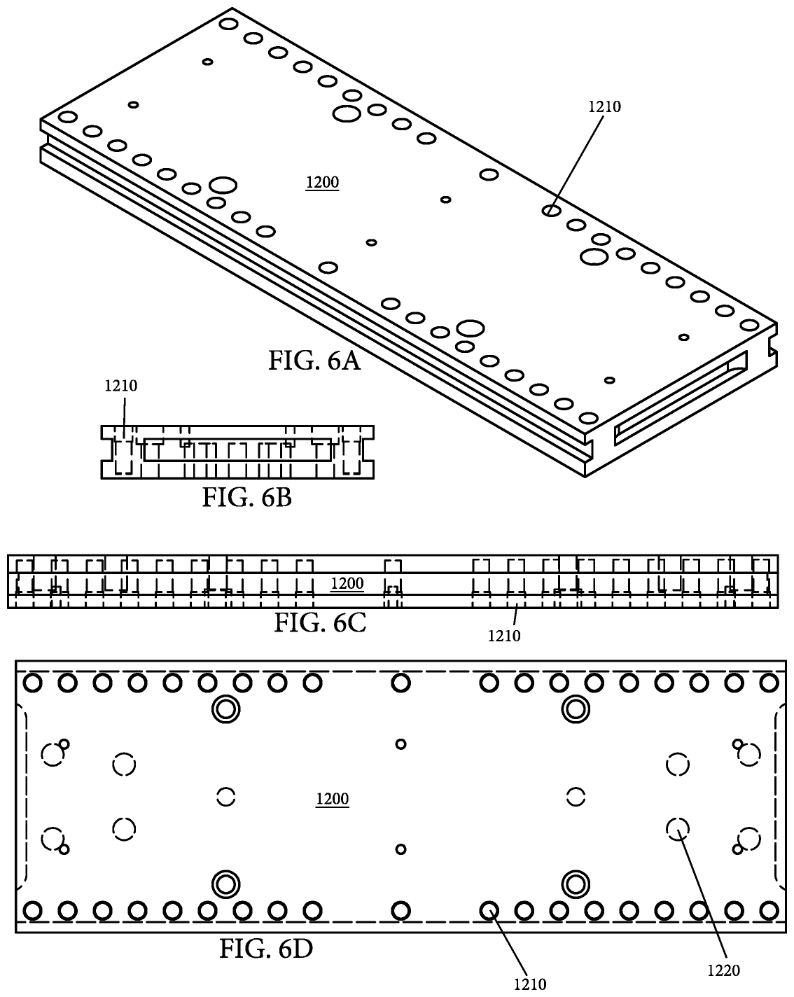

FIGS. 6A-D show the main body base 1200 with various views of the jaw securing openings 1210 and post holes 1220 penetrating the main body base 1200. FIG. 6A is a perspective view of a reconfigurable double-station vise base 1200. FIG. 6D is a top plan view of the reconfigurable the double-station vise base of FIG. 6A. Referring to FIGS. 6A and 6D first, the base is suitably rectangular with a top surface that features a series of post holes 1210 positioned in parallel alignment lengthwise over the base. FIG. 6B is a front or back view of the reconfigurable the double-station vise base of FIG. 6A. FIG. 6C is a left or right side view of the reconfigurable the double-station vise base of FIG. 6A.

FIGS. 6A through 6D show a main body base 1200 comprising jaw securing openings 1210. In one embodiment, the main body base 1200 may be in the range of 20.00 to 24.00 inches in length and 5.00 to 9.00 inches in width. In an alternative embodiment, the main body base 1200 measures 22.00 inches in length and 7.75 inches in width. Referring to FIGS. 6B and 6C, the main body base 1200 may reach 1.50 inches in thickness. Movable jaws 1300, a center jaw piece 1400, and end plates 1100 move along the main body base and align with the jaw securing openings 1210. Suitably, jaw piece securing studs 2000 fixate the moveable jaw pieces to the main body base 1200. Once the moveable jaw pieces, discussed below, are fixated to the main body base 1200, the perpendicular fixation and connection to an lead screw 5000 permits parallel movement of the movable jaws 1300 via guide rods 3000 fixated coaxially to the end plates 1100.

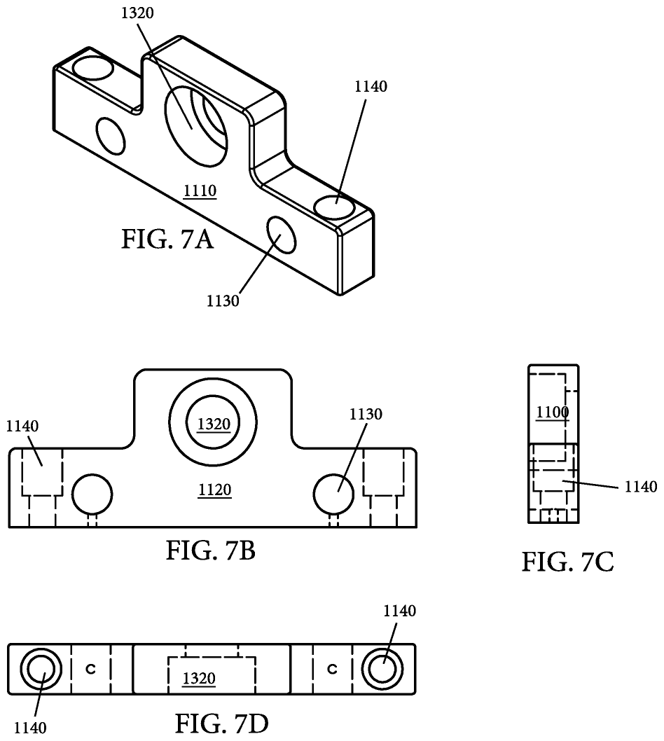

FIGS. 7A-D show the end plate 1110 with two guide rod openings 1130, stud openings 1140, and lead screw opening 1320 isolated from the reconfigurable double-station vise apparatus 1000. FIG. 7A is a perspective view of a reconfigurable double-station vise end plate. FIG. 7A shows the external wall 1110 of the end plate. FIG. 7B is an orthogonal back side view of the reconfigurable double-station vise end plate of FIG. 7A. FIG. 7B shows the internal wall 1120 of the end plate 1100. FIG. 7B is an orthogonal back side view of the reconfigurable double-station vise end plate of FIG. 7A. FIG. 7C is an orthogonal left side view of the reconfigurable double-station vise end plate of FIG. 7A. FIG. 7D is an orthogonal top view of the reconfigurable double-station vise end plate of FIG. 7A. Suitably, the depicted stud openings 1140, lead screw opening 1320, and guide rod openings 1130 are circular openings that completely transverse the end plates 1100. The lead screw opening 1320 and guide rod openings 1130 transverse the end plate 1100 vertical surface. The stud openings 1140 transverse the end plate 1100 top horizontal surface.

FIGS. 7A-D show the end plates 1110. The end plates 1100 fixate to the main body base 1200 through insertion of jaw securing studs 2000 into stud openings 1140 and subsequently varying post holes 1220. Once secured to the main body base 1200, a guide rod 3000 is inserted through the guide rod opening 1130 to connect to and permit the lateral movement of the movable jaw 1300. A lead screw 5000 inserts and anchors to the lead screw opening 1320 and connects to the movable jaw 1300 to facilitate lateral movement of the movable jaw 1300 via twisting of the lead screw 5000. In one embodiment, the end plate 1110 may range from 5.00 to 9.00 inches in length and 0.25 to 2.00 inches in width. In an alternative embodiment, the end plate 1110 measures 7.75 inches in length and 0.95 inches in width. Referring to FIG. 7C, the end plate 1100 may measure 3.00 inches in height.

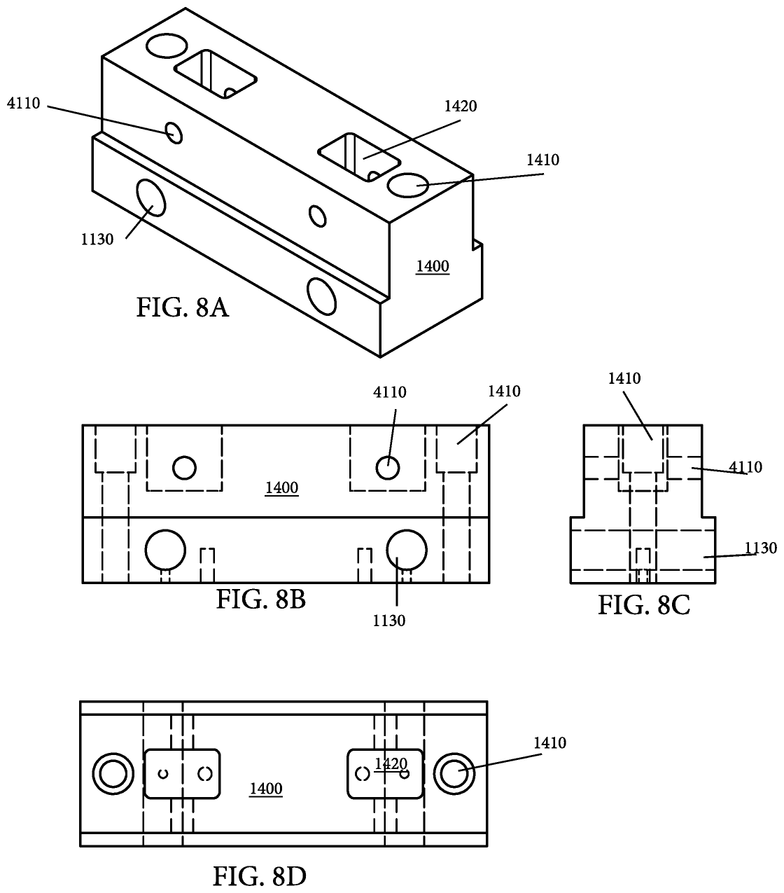

FIGS. 8A-D show the center jaw piece 1400. FIG. 8A is a perspective view of a reconfigurable double-station vise center jaw piece. As shown, the center jaw piece 1400 features guide rod openings 1130, jaw plate securing stud openings 4110, center piece securing openings 4110, and securing stud access opening 1420. FIG. 8B shows an orthogonal view of the center jaw piece 1400 with the guide rod openings 1130 and center piece securing openings 1410 perforating the vertical surface of the center jaw piece 1400. FIG. 8C is an orthogonal left or right side view of the reconfigurable double-station vise center jaw piece of FIG. 8A. FIG. 8D shows an orthogonal view of the center jaw piece 1400 from above. The center piece securing openings 1410 transverse the upper horizontal surface of the center jaw piece 1400 and provide a through opening to the bottom horizontal surface. The securing stud access openings 1420 partially transverse the center jaw piece 1400. In one embodiment, the securing stud access openings 1420 provide access to the distal ends of at least one jaw plate securing stud 4000 that is inserted through the jaw plate securing stud openings 4110 in order to secure the jaw plate securing stud 4000 to the center jaw piece 1400. The accessibility provided by the securing stud access opening 1420 permit the alignment of the jaw plate securing stud openings 4110 on opposing vertical surfaces of the center jaw piece 1400. This alignment facilitates uniformity of alignment when working with two different work pieces on the reconfigurable double-station vise 1000.

FIGS. 8A-D and 10 through 11E show the center jaw piece 1400. The center jaw piece fixates coaxially to the main body base 1200 via meeting the jaw plate securing studs 4000 with the jaw securing openings 1410. The center jaw piece 1400 exhibits jaw plate securing studs 4000 that connect to the jaw plate securing stud openings 4110 for the fixation of various jaw plates to secure work pieces. In one embodiment, the center jaw piece 1400 may be in the range of 5.00 to 9.00 inches in length and 1.00 to 4.00 inches in height. In an alternative embodiment, the center jaw piece 1400 measures 7.75 inches in length and 3.00 inches in height. Referring to FIG. 8D, the center jaw piece 1400 may be 2.75 inches in width.

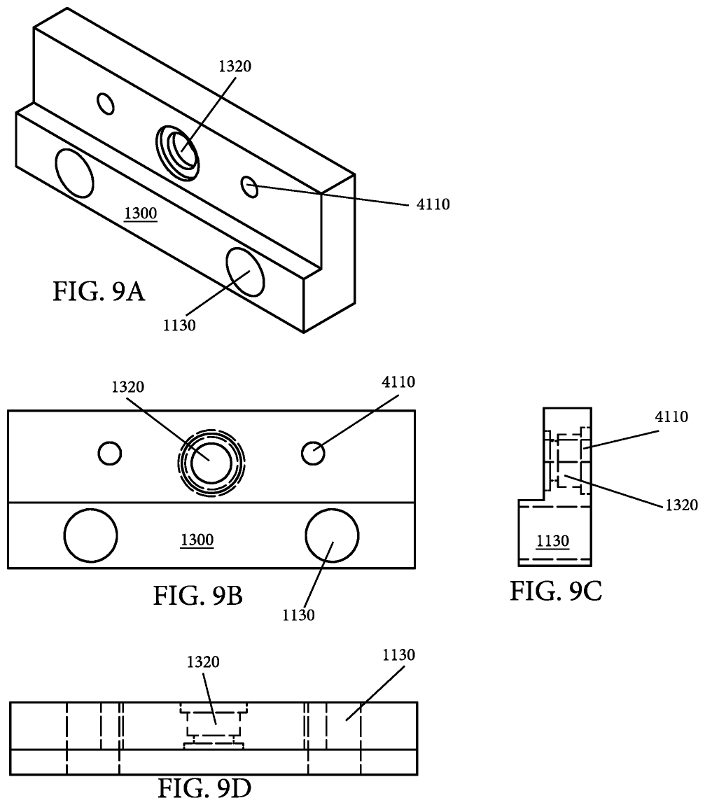

FIGS. 9A-D show the movable jaw 1300 with guide rod openings 1130, jaw plate securing stud openings 4110, and a lead screw opening 1320. FIGS. FIG. 9A is a perspective view of a reconfigurable double-station vise movable jaw 1300. FIG. 9B is an orthogonal view of the reconfigurable double-station vise movable jaw of FIG. 9A. FIG. 9C is an orthogonal back side view of the reconfigurable double-station vise movable jaw of FIG. 9A. FIG. 9D is an orthogonal top plan view of the reconfigurable double-station vise movable jaw of FIG. 9A. In one embodiment, the movable jaw 1300 may be in the range of 5.00 and 9.00 inches in length and 0.50 and 3.00 inches in width. In an alternative embodiment, the movable jaw 1300 measures 7.75 inches in length and 1.375 inches in width. Referring to FIG. 9C, the movable jaw 1300 may measure 3.00 inches in height.

10A-D show environmental views of the reconfigurable double-station vise apparatus 1000 with the movable jaws 1300 being laterally adjusted along the main body base 1200 by twisting the lead screw 5000. FIGS. 1, 3, 10 and 11 show the lead screw 5000. The lead screw connects the end plates 1110 to the movable jaw 1300 via insertion through the guide rod 3000 on the respective pieces. Suitably, twisting or turning the crank and the lead screw 5000 causes the movable jaw 1300 to move laterally along the main body base 1200. This movement allows for the securing of work pieces between the center jaw piece 1400 and the movable jaw 1300.

FIG. 10A is a perspective view. FIG. 10B is an environmental front view. FIG. 10C is an environmental side view. FIG. 10D is an environmental top plan view of the reconfigurable double-station of FIG. 10A. The figures show standard operation of the vise 1000. Referring to the figures (FIGS. 10A-D) the movable plates may be advanced toward or away from the center jaw 1400 along the guide rods 3000 by turning the crank and lead screw 5000.

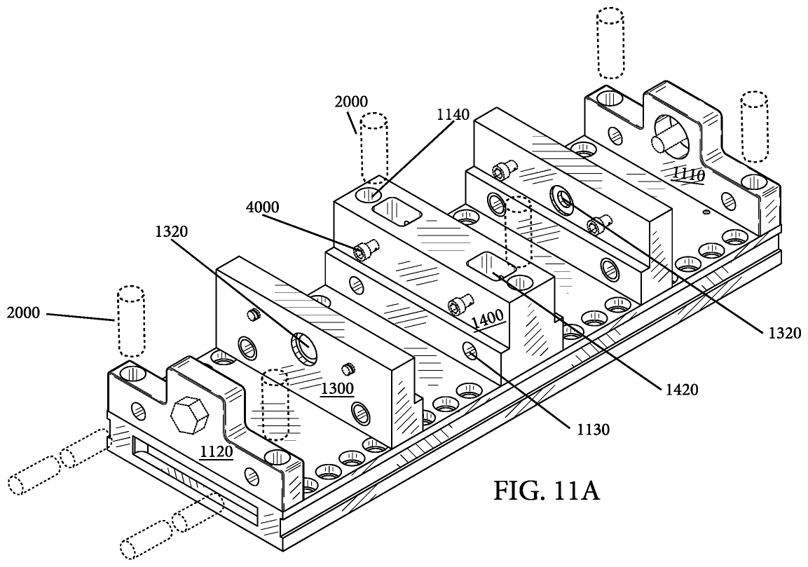

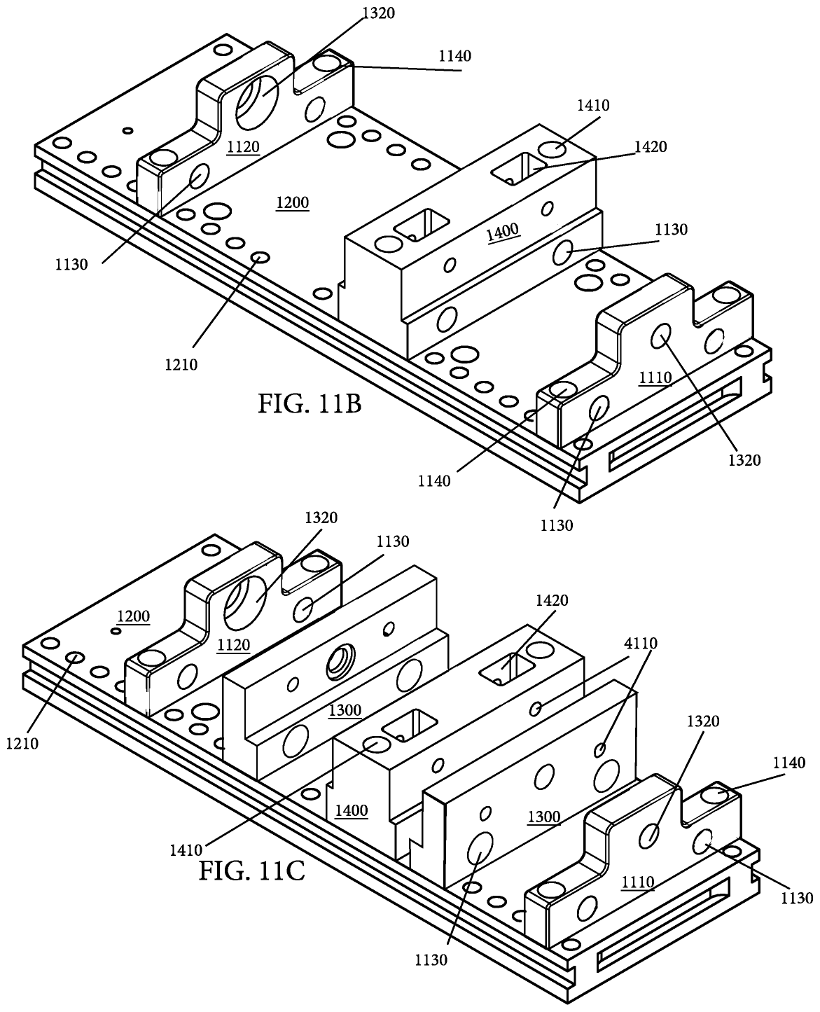

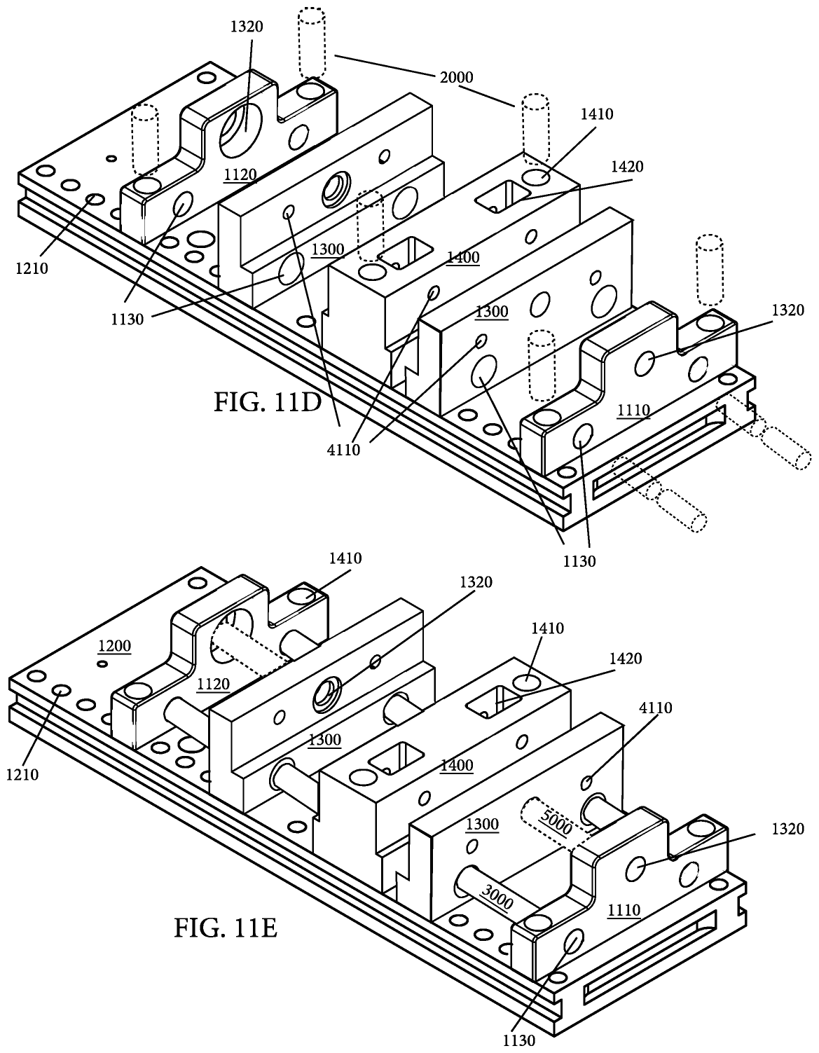

FIG. 11A is a perspective view of a reconfigurable double-station vise showing the removal of removable, stabilizing plugs 2000 from the center jaw piece 1400 and end plates 1100. FIG. 11B is an environmental view of a reconfigurable double-station vise 1000 showing alternative placement of the center jaw piece 1400 and end plates 1100 with movable jaws 1300 (not shown) removed. FIG. 11C is an environmental view of a reconfigurable double-station vise 1000 showing alternative placement of the center jaw piece 1400 and end plates 1100 with movable jaws 1300 repositioned along the base 1200. FIG. 11D is an environmental view of a reconfigurable double-station vise with alternative placement of the center jaw piece and end plates with movable jaws placed on the reconfigurable double-station vise base secured to the base with removable, stabilizing plugs 2000 inserted into the center jaw piece 1400, end plates 1100, and movable jaws 1300. FIG. 11E is an environmental view of a reconfigurable double-station vise 1000 of FIG. 11D with stabilizing plugs 2000 inserted into the center jaw piece 1400, end plates 1100, and movable jaws 13000 and an lead screw 5000 coaxially connecting the end plats to the movable jaws.

FIGS. 11A-E show the reconfigurable double-station vise apparatus 1000 being assembled through the removal, readjustment of position, and resecuring of the center jaw piece 1400, movable jaw 1330, and end plates 1110 along the base with jaw piece securing studs 2000 and an lead screw 5000. Referring first to FIG. 11A, the securing studs 2000 may guide rod 3000 may be removed from the assembled vise of FIGS. 10A through 10D. As shown, the movable jaw 1300 is secured to the main body base 1200 via connection of the jaw piece securing studs 2000 to the jaw securing openings 1210. Once fixated to the main body base 1200, two guide rods 3000 are inserted into shaft openings 1310 located on the end plates 1110, movable jaw 1300, and the center jaw piece. A lead screw 5000 is inserted in the lead screw openings 1320 in the end plates 1110 and movable jaw 1300.

In use, the double vise apparatus 1000 may secure a work piece in place by adjusting at least one lead screw 5000, wherein at least one movable jaw 1300 is maneuvered to a distance to secure a work piece against a jaw plate. In another embodiment, the center jaw piece 1400 may be removed to allow for a larger work piece to be secured between the two movable jaws 1300.

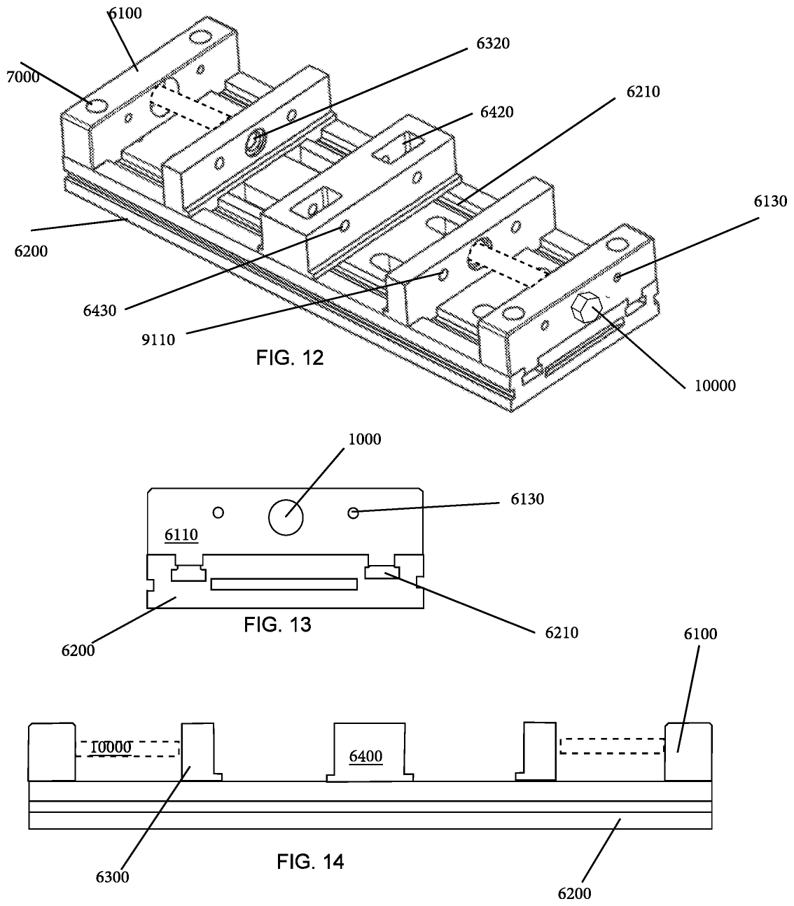

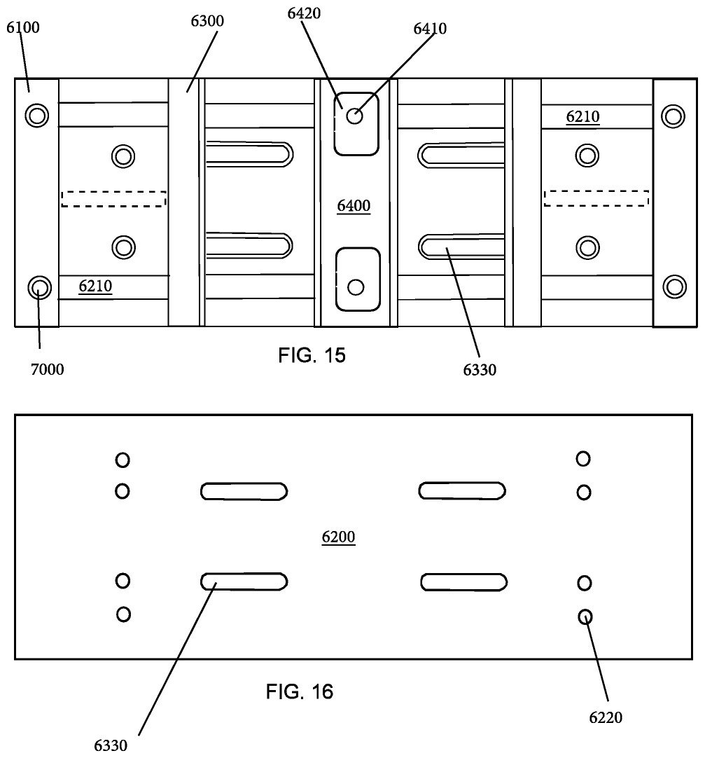

FIGS. 12 through 16 show an alternate embodiment of a double station vise 6000. FIG. 12 is a perspective view of the reconfigurable double-station vise 6000 showing the center jaw piece 6400, two movable jaws 6300, two end plates 6100, fixated to the main body base 6200 via removable, jaw securing studs 7000. FIG. 13 is an orthogonal view of a reconfigurable double-station vise 6000 from FIG. 12 showing the external wall 6110 of the end plate 6100, the lead screw 10000 and the end plate securing stud openings 6130. FIG. 14 is an orthogonal left or right side view of a reconfigurable double-station vise 6000 from FIG. 12 showing the center jaw piece 6400, movable jaw 6300, and end plates 6100 coaxially fixated to the main body base 6200. FIG. 15 is an orthogonal top plan view of a reconfigurable double-station vise 6000 from FIG. 12 showing the end plates 6100, the movable jaw 6300, and center jaw piece 6400 fixated to the main body base 6200 via center piece securing openings 6410.

As shown in FIGS. 12 through 16, the vise 6000 features a base where two jaw rail openings 6210 are creviced into the main body base 6200. The end plates 6110, movable jaws 6300, and center jaw piece 6400 are inserted into the jaw rail openings 6210 and laterally slide along the jaw rail openings 6210. The lead screw 10000 connects the end plates 6100 to the movable jaws 6300. Incremental lateral movement of the movable jaws 6300 is achieved via twisting the lead screw 10000 from its distal end protruding from the center of the end plate 6100. The end plates 6100 are secured to the main body base 6200 via jaw piece securing studs 7000 that are provided into stud openings 6140 and inserted into the jaw rail openings 6210. FIG. 14 also shows the lead screws 10000 connecting the end plates 6100 to the movable jaws 6300 with jaw plate securing studs 7000 coaxially fixated to the movable jaws 6300 and center jaw piece 6400. In one embodiment, the end plates 6100, movable jaw 6300, and the center jaw piece 6400 are all fixated to the main body base 6200 to allow for two separate work pieces to be secured between the center jaw piece 6400 and either movable jaw 6300 on opposing sides of the center jaw piece 6400. FIG. 15 also gives an orthogonal view of the reconfigurable double-station vise apparatus 6000 from the top showing jaw rail openings 6210 along the main body base 6200 with the moveable jaw base openings 6330 located centrally and perforating the main body base 6200. FIG. 16 is an orthogonal bottom plan view of a reconfigurable double-station vise 6000 from FIG. 12 showing the main body base 6200 with post holes 6220 for securement to a machine tool table and the moveable jaw base openings 6330 transversing the main body base 6200.

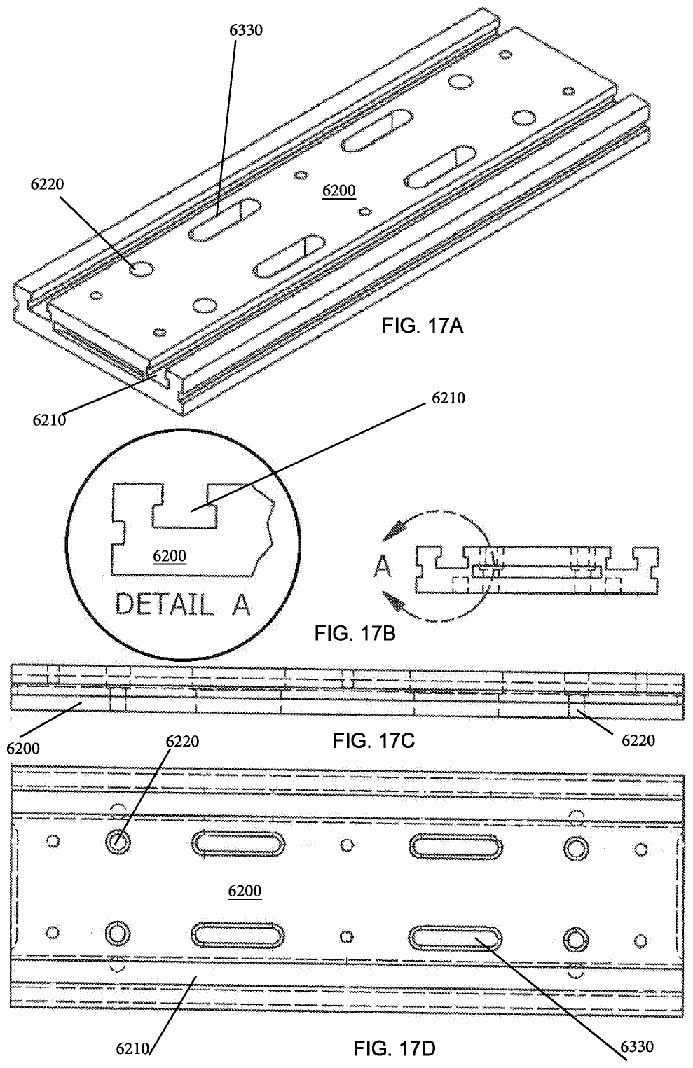

FIGS. 17A-D show the main body base 6200 with various views of the jaw rail openings 6210 and post holes 6220 penetrating the main body base 6200. FIG. 17A is a perspective view of a reconfigurable double-station vise base. FIG. 17B is a front or back view of the reconfigurable the double-station vise base of FIG. 17A. FIG. 17C is a left or right side view of the reconfigurable the double-station vise base of FIG. 17A. FIG. 17D is a top plan view of the reconfigurable the double-station vise base of FIG. 17A.

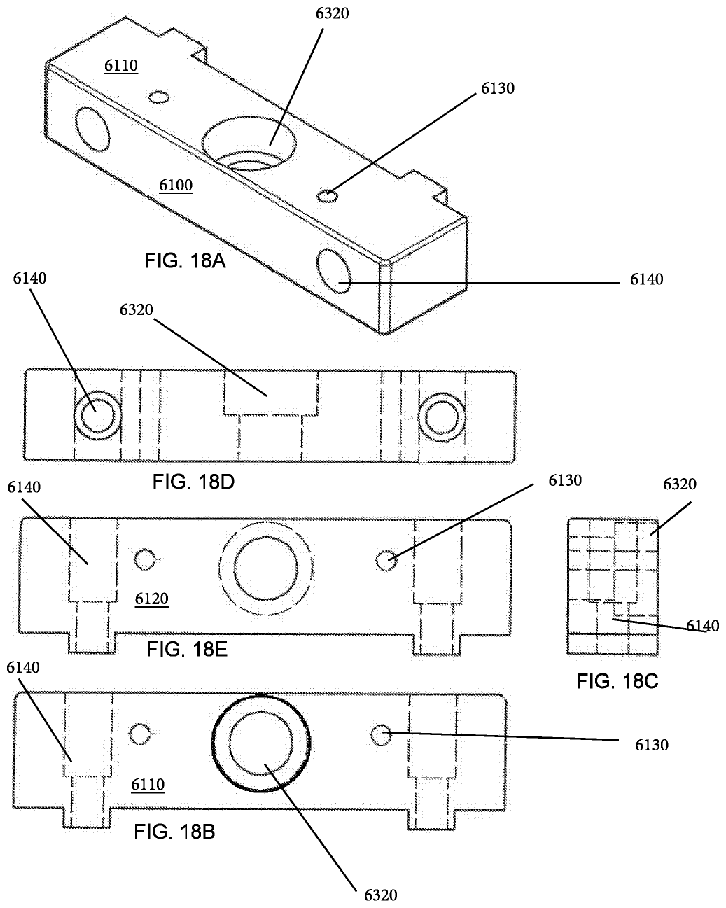

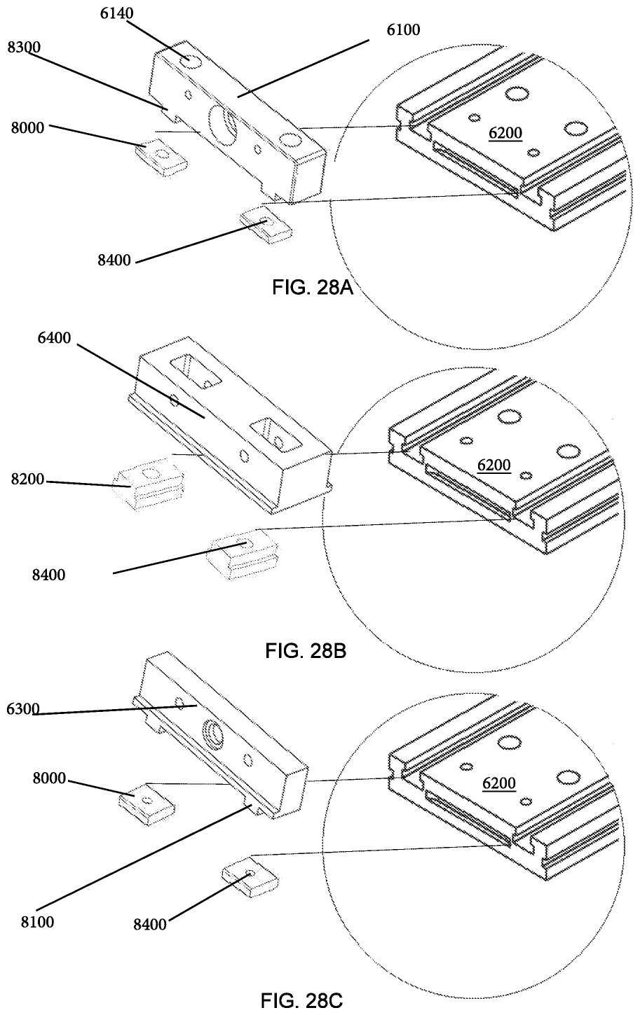

FIGS. 18A-E show the end plate 6100 with two end plate securing stud openings 6130, stud openings 6140, and lead screw opening 6320 isolated from the reconfigurable double-station vise apparatus 6000. FIG. 18A is a perspective view of a reconfigurable double-station vise end plate 6100 showing the external wall 6110 of the end plate. FIG. 18E shows the internal wall 6120 of the end plate 6100. FIG. 18B shows the external wall 6110 of the end plate 6100. FIG. 18C is an orthogonal left side view of the reconfigurable double-station vise end plate 6100. FIG. 18D is an orthogonal top view of the reconfigurable double-station vise end plate of FIG. 18A. FIG. 18E is an orthogonal front side view of the reconfigurable double-station vise end plate of FIG. 18A. As shown in the figures, the stud openings 6140, lead screw opening 6320, and end plate securing stud openings 6130 are suitably circular openings that completely transverse the end plates 6100. Preferably, the lead screw opening 6320 and end plate securing stud openings 6130 transverse the end plate 6100 vertical surface. In the preferred embodiment, the stud openings 6140 transverse the end plate 6100 top horizontal surface to facilitate securement of the end plate to the base (see FIG. 28A).

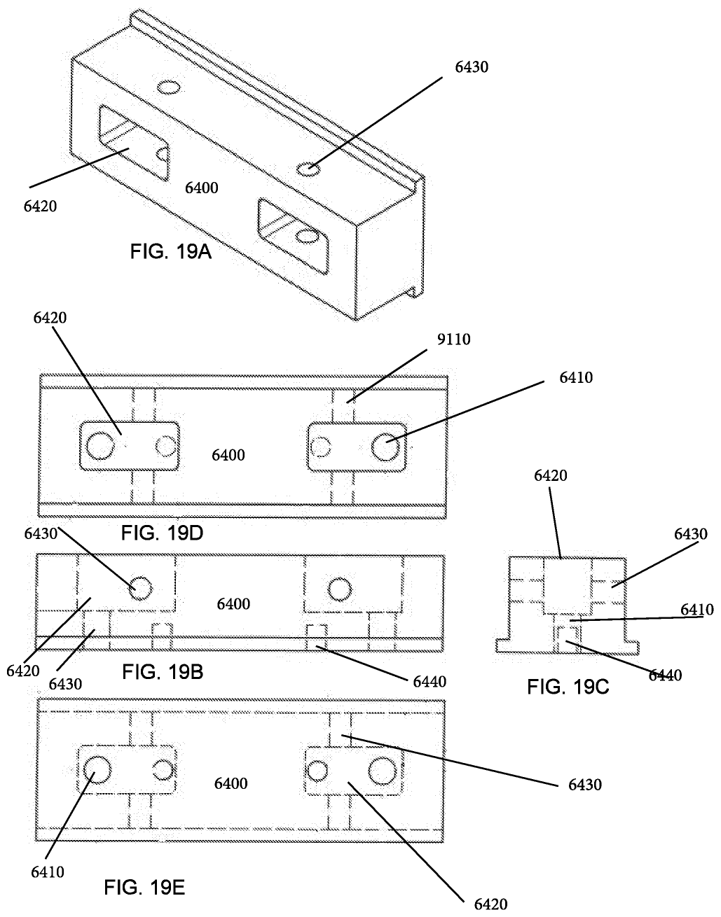

FIGS. 19A-E show the center jaw piece 6400 with jaw plate securing stud openings 9110, center piece securing openings 6410, and securing stud access opening 6420. FIG. 19A is a perspective view of a reconfigurable double-station vise center jaw piece 6400. FIG. 19B shows an orthogonal view of the center jaw piece 6400 with center piece securing openings 6410 perforating the vertical surface of the center jaw piece 6400. FIG. 19C is an orthogonal left or right side view of the reconfigurable double-station vise center jaw 6400. FIG. 19D is an orthogonal top view of the reconfigurable double-station vise center jaw piece of FIG. 19A. FIG. 19E shows an orthogonal bottom view of the reconfigurable double-station vise center jaw piece 6400.

As shown in FIGS. 19A-E, the center piece securing openings 6410 suitably transverse the upper horizontal surface of the center jaw piece 6400 and provide a through opening to the bottom horizontal surface. The securing stud access opening 6420 partially transverse the center jaw piece 6400. In one embodiment, the securing stud access openings 6420 provide access to the distal ends of at least one jaw plate securing stud 9000 that is inserted through the jaw plate securing stud openings 6430 in order to secure the jaw plate securing stud 9000 to the center jaw piece 6400. In one embodiment, the accessibility provided by the securing stud access openings 6420 permit the alignment of the jaw plate securing stud openings 6430 on opposing vertical surfaces of the center jaw piece 6400. This preferred alignment facilitates uniformity of operation when working with two different work pieces on the reconfigurable double-station vise 6000. In one instance, the center jaw foot peg opening 6440 partially transverses the center jaw piece 6400 from the bottom. As discussed below in connection with FIG. 28B, the center jaw foot peg opening 6440 allows for connection of the center jaw piece 6400 to the jaw feet 8000.

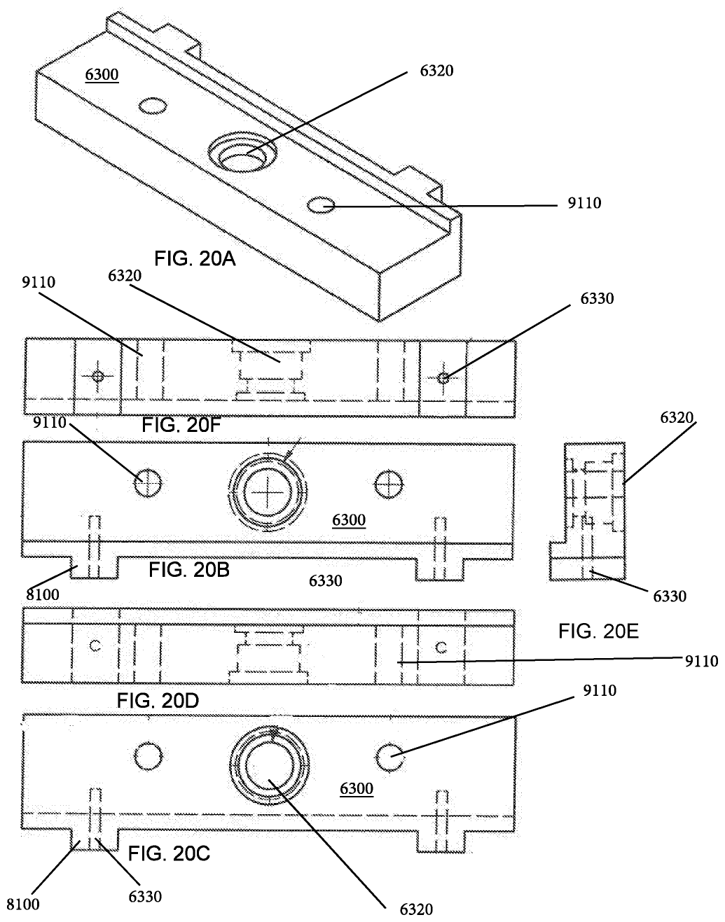

FIGS. 20A-F show the movable jaw 6300, jaw plate securing stud openings 9110, moveable jaw foot 8100, moveable jaw foot peg openings 6330, and a lead screw opening 6320. FIG. 20A is a perspective view of a reconfigurable double-station vise movable jaw. FIG. 20B is an orthogonal front view of the reconfigurable double-station vise movable jaw of FIG. 20A. FIG. 20C is an orthogonal back side view of the reconfigurable double-station vise movable jaw of FIG. 20A. FIG. 20D is an orthogonal top plan view of the reconfigurable double-station vise movable jaw of FIG. 20A. FIG. 20E is an orthogonal side view of the reconfigurable double-station vise moveable jaw 6300. FIG. 20F is an orthogonal view of the moveable jaw 6300 from the bottom, showing the moveable jaw foot peg openings 6330.

FIG. 21A is a perspective view of a foot for a reconfigurable double-station vise end plate. FIG. 21B is a side view of a foot for the reconfigurable double-station vise end plate of FIG. 21A. FIG. 21C is a plan view of a foot for the reconfigurable double-station vise end plate of FIG. 21A. FIG. 21D is another side view of a foot for the reconfigurable double-station vise end plate of FIG. 21A. FIG. 28A shows assembly of the foot to the end plate 6100.

FIG. 22A is a perspective view of a foot for a reconfigurable double-station vise moveable jaw. FIG. 22B is a side view of a foot for the reconfigurable double-station vise movable jaw of FIG. 22A. FIG. 22C is a plan view of a foot for the reconfigurable double-station vise movable jaw of FIG. 21A. FIG. 22D is another side view of a foot for the reconfigurable double-station vise movable jaw of FIG. 21A. FIG. 28C shows assembly of the foot to the movable jaw 6300.

FIG. 23A is a perspective view of a lead nut for the movable plate. FIG. 23B is front view of the lead nut of FIG. 23A. FIG. 23C is a cross-section view of the lead nut of FIG. 23A. Referring to FIGS. 18A through 18E, the lead nut may be provided to the end piece 6300 to provide threads to the end piece 6300 so that rotation of the lead screw through the lead nut move the leadscrew therethrough.

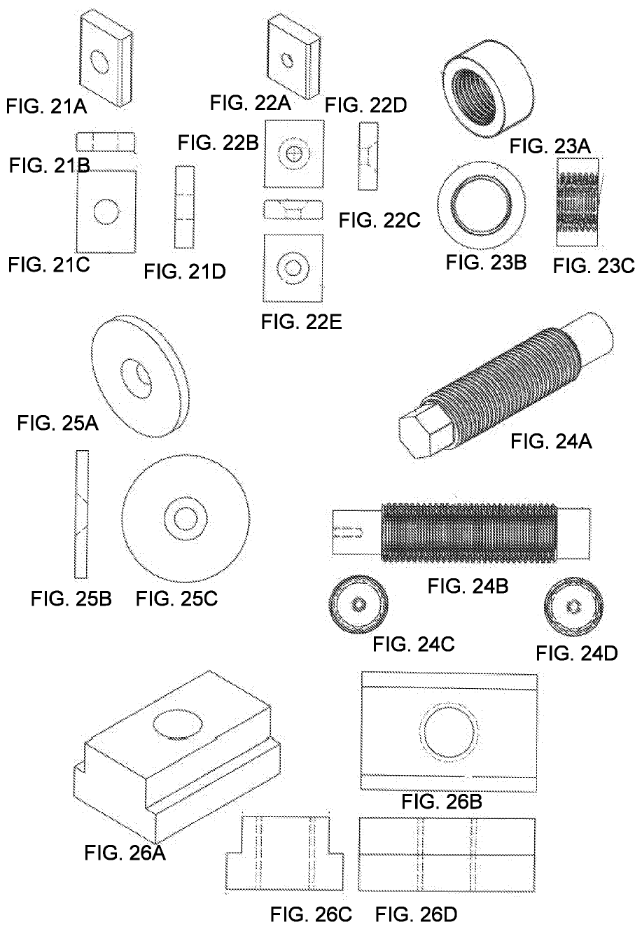

FIG. 24A is a perspective view of a lead screw for the movable plate. FIG. 24B is a side view of the lead screw of FIG. 24A. FIG. 24C is a front view of the lead screw of FIG. 24A. FIG. 24D is a back view of the lead screw of FIG. 224A.

FIG. 25A is a perspective view of a lead washer for the movable plate. FIG. 25B is side view of the lead washer of FIG. 25A. FIG. 25C is a plan view of the lead nut of FIG. 25A. Referring to FIGS. 20A through 20F, the washer may be provided to rotatably secure the lead screw (see FIG. 24B) to the movable jaw 6300.

FIG. 26A is a perspective view of a foot for a reconfigurable double-station vise center jaw piece. FIG. 26B is a top view of a foot for the reconfigurable double-station vise center jaw piece of FIG. 26A. FIG. 26C is a side view of a foot for the reconfigurable double-station vise center jaw piece of FIG. 26A. FIG. 26D is another side view of a foot for the reconfigurable double-station vise center jaw piece of FIG. 26A. FIG. 28B shows assembly of the foot to the center jaw piece 6400.

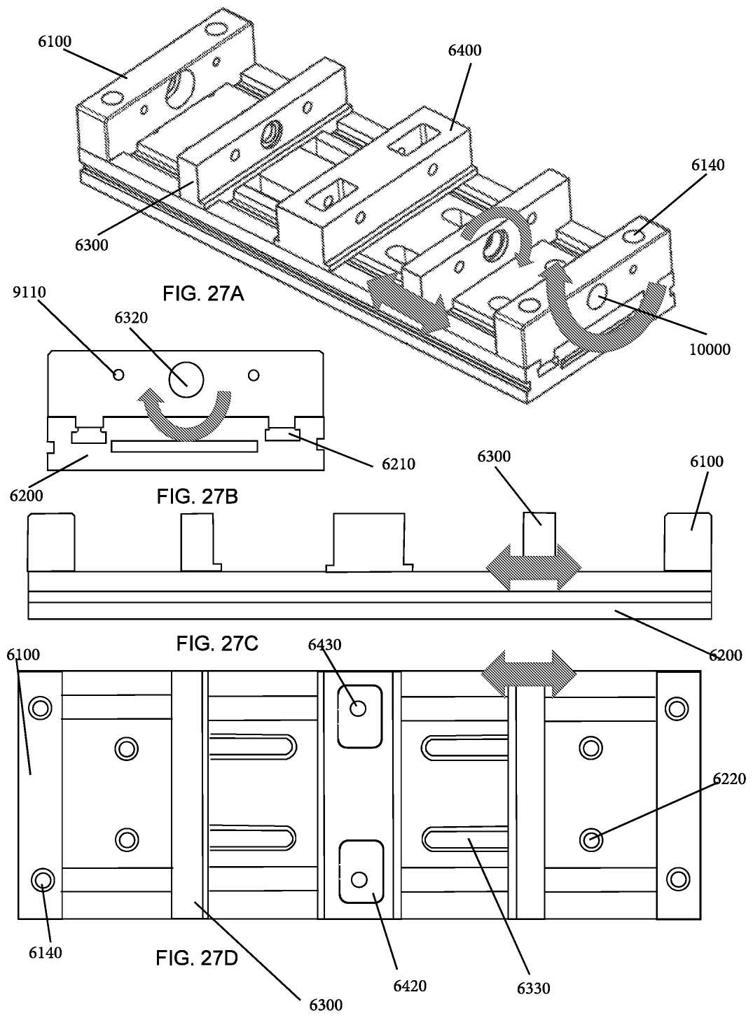

FIG. 27A is an environmental view of a reconfigurable double-station vise with movable jaws 6300 being incrementally adjusted along the main body base 6200 via a lead screw coaxially connecting the end plate 6100 to the movable jaw 6300. FIG. 27B is an environmental view of a reconfigurable double-station vise end plate showing a lead screw being turned or cranked to adjust the movable jaw location along the base. FIG. 27C is an environmental side view of the reconfigurable double-station vise of FIG. 27A. FIG. 27D is an environmental top plan view of the reconfigurable double-station vise of FIG. 27A. 27A-D show environmental views of the reconfigurable double-station vise 6000 with the movable jaws 6300 being laterally adjusted along the length of the main body base 6200 via the jaw rail openings 6210 by twisting the lead screw 10000.

FIG. 28A is a schematic for assembling the disclosed reconfigurable double-station vise 6000 end plate 6100 and jaw feet 8000. The jaw feet 8000 connects to the end plate 6100 through alignment of the end plate stud openings 6140 with the jaw foot peg openings 8400 and subsequent insertion of a peg or shaft through the aligned openings. Once the jaw feet 8000 are connected to the end plate jaw foot 8300, the jaw feet 8000 may be inserted into the jaw rail openings 6210, permitting lateral movement of the end jaw plate 6100 along the main body base 6200. FIG. 28B is a schematic for assembling the disclosed reconfigurable double-station center jaw 6400 and center jaw foot 8200. FIG. 28C is a schematic for assembling the disclosed reconfigurable double-station vise movable jaw 6300 and jaw feet 8000. Once the feet are provided to the track, as shown, the components may be moved along the tracks of the base to any lengthwise position and secured to a position via selective tightening or loosening of screws or posts so that the lips of the track are sandwiched between the foot and the end plate 6100 or center jaw plate 6400.

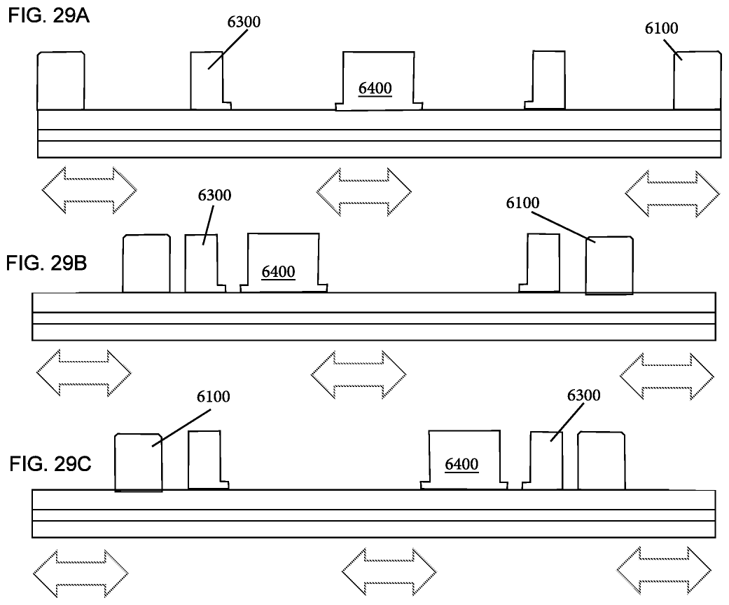

FIGS. 29 A-C show environmental views of the reconfigurable double-station vise 6000 with alternative placement of the center jaw piece 6400 and end plates 6100 with moveable jaws 6300 placed on the reconfigurable double-station vise main body base 6200. As shown in FIGS. 29 A-C, the center jaw piece 6400, moveable jaws 6300, and end plates 6100 are positionally adjustable along the main body base 6200. Each piece is independently moveable along the main body base 6200 with the central jaw piece 6400 located centrally amongst the moveable pieces, permitting an asymmetrical configuration between the center jaw piece 6400 and the oppositionally positioned moveable jaws 6300 and end plates 6100.

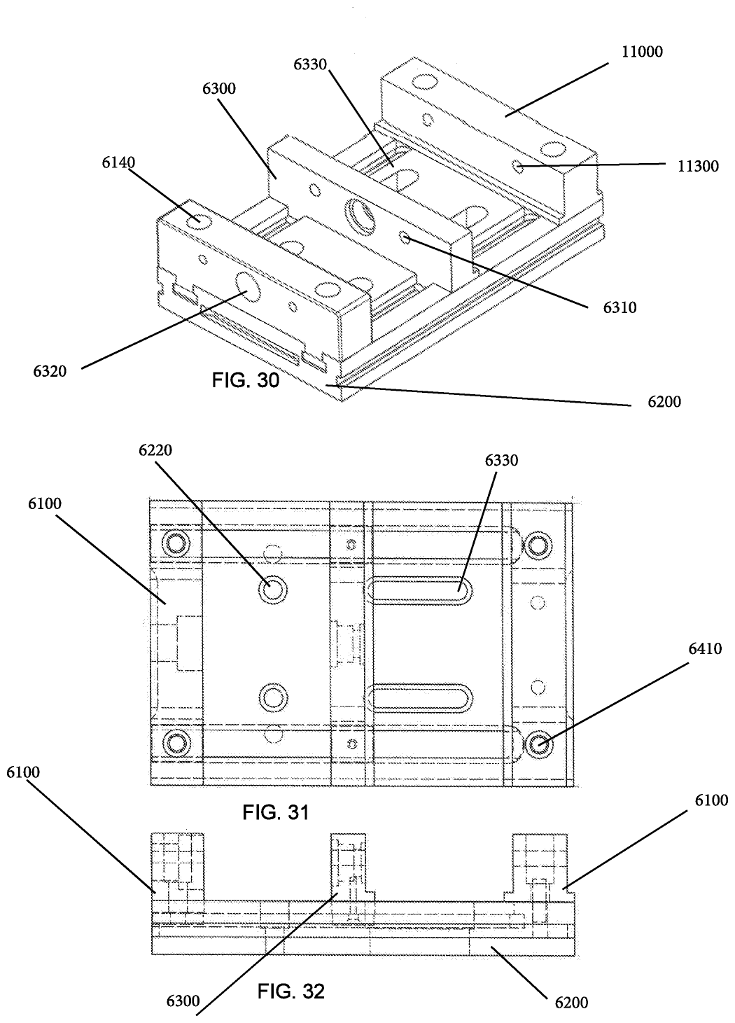

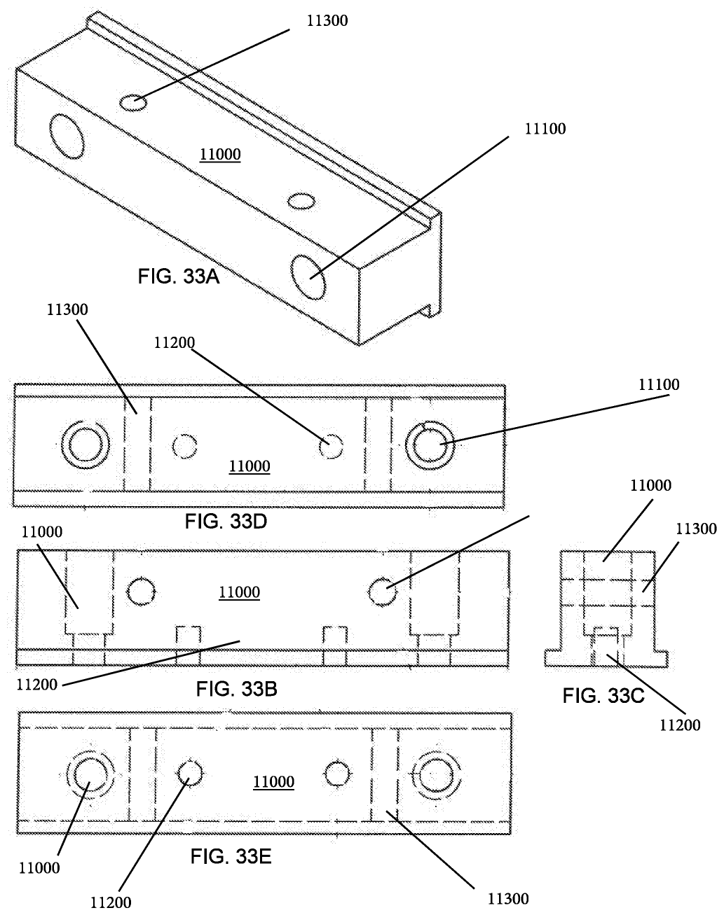

FIG. 30 is a perspective view of a reconfigurable double-station vise 6000 comprising a centrally positioned moveable jaw 6300, an end plate 6100, and a fixed jaw 11000. The fixed jaw 11000 permits a single half of the reconfigurable double-station vise 6000 to be utilized without engaging with both end plates 6100 and the center jaw piece 6400. FIG. 31 is an orthogonal top plan view of the reconfigurable double-station vise from FIG. 30, and FIG. 32 is an orthogonal left or right side view of the reconfigurable double-station vise 6000. FIG. 33A shows a reconfigurable double-station vise fixed jaw 11000. The fixed jaw 11000. The fixed jaw 11000 permits FIG. 33B is an orthogonal front or back side view of the fixed jaw 11000 of FIG. 33 A, FIG. C is an orthogonal left or right side view of the fixed jaw 11000 of FIG. 33A, and FIG. D is an orthogonal top view of the fixed jaw 11000 of FIG. 33A.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A double station vise apparatus comprising:
a base with a first end and a second end and at least one track that extends from a first end the length of the base to the second end of the base;
a first end plate reconfigurably secured to the first end of the base within the track of the base via a foot of said first end plate, wherein the foot of said first end plate is tightened against the lip of the track;
a second end plate reconfigurably secured to the second end of the base within the track of the base via a foot of said second end plate, wherein the foot of said second end plate is tightened against the lip of the track;
a first movable jaw that is slidably secured along the track;
a second jaw that is slidably secured along the track;
a first lead screw that extends from the first end plate to the first jaw set, wherein the first lead screw slides the first jaw set along the track;
a second lead screw that extends from the second end plate to the second jaw set, wherein the second lead screw slides the second jaw set along the track; and,
a removable center jaw piece that is slidably secured along the track and centrally and reconfigurably located on the base via a foot of the removable center jaw piece, wherein the foot of the removable center jaw piece is tightened against the lip of the track.

2. A method of securing a machining work piece to a vise using the double station vise of claim 1 comprising the steps of:
loosening the foot of the center jaw piece from the lip of the track;
sliding the center jaw piece along the track from a first position to a second position; and,
tightening the foot of the center jaw piece to the lip of the track.

3. The method of claim 2 further comprising the step of:
loosening the foot of the first end plate from the lip of the track;
sliding the first end plate along the track from an initial position to a terminal position; and,
tightening the foot of the first end plate to the lip of the track.

4. The method of claim 3 further comprising the step of:
loosening the foot of the second end plate from the lip of the track;
sliding the second end plate along the track from a beginning position to an ending position; and,
tightening the foot of the second end plate to the lip of the track.

5. A double station vise apparatus comprising:
a base with a first end and a second end, said base featuring at least one series of jaw securing openings;
a first end plate reconfigurably secured to the first end of the base via a stud provided through the end plate into one of said jaw securing openings of said series of jaw securing openings;
a second end plate reconfigurably secured to the second end of the base via another stud provided through the second end plate into another one of said jaw securing openings of said series of jaw securing openings;
at least one guide rod that extends from the first end plate the length of the base to the other end plate;
a first jaw set that is slidably secured along the guide rod;
a second jaw set that is slidably secured along the guide rod;
a first lead screw that extends from the first end plate to the first jaw set, whereby the first lead screw slides the first jaw set along the guide rod;
a second lead screw that extends from the second end plate to the second jaw set, whereby the second lead screw slides the second jaw set along the guide rod; and,
a removable center jaw piece that is slidably secured along the guide rod and centrally and reconfigurably located on the base via yet another stud provided through the removable center jaw piece into yet another one of said jaw securing openings of said series of jaw securing openings.

6. A method of securing a machining work piece to a vise comprising the steps of:
obtaining a double vise apparatus comprising a base with a first end and a second end, a first end plate secured to the first end of the base, a second end plate secured to the second end of the base, at least one guide rod or track that extends from the first end plate along the length of the base to the other end plate, a first jaw set that is slidably secured along the guide rod or track, a second jaw set that is slidably secured along the guide rod or track, a first lead screw that extends from the first end plate to the first jaw set, whereby the first lead screw slides the first jaw set along the guide rod or track, a second lead screw that extends from the second end plate to the second jaw set, whereby the second lead screw slides the second jaw set along the guide rod or track, and a removable center jaw piece that is slidably secured along the guide rod or track and centrally located on the base;
obtaining a machining work piece;
adjusting the first lead screw until the first end plate is at a desired location along the double vise apparatus;
obtaining at least one face plate;
securing a face plate to the first jaw set;
securing a face plate to the wall opposing the first jaw set on the center jaw piece;
placing the machining work piece between the two face plates; and,
adjusting the first lead screw until the machining piece is secured between the two face plates.
